(19) United States
(12) Patent Application Publication
(10) Pub. No.: US 2006/0227559 A1
(43) Pub. Date: Oct. 12, 2006

(54) Lamp having an eggshell shade

(76) Inventor: Jerome Migdoll, Jersey City, NJ (US)

Correspondence Address: OSTROLENK FABER GERB & SOFFEN, 1180 AVENUE OF THE AMERICAS, NEW YORK, NY, 100368403, US

(21) Appl. No.: 11/099,896

(22) Filed: Apr. 6, 2005

(51) Int. Cl. F21V 11/00

(52) U.S. Cl. 362/361

(57) ABSTRACT

A lamp, including a base and a tubular member having a top and a bottom, the bottom being attached to the base. A light socket is arranged in the top of the tubular member. A lamp shade support member is arranged at the top of the tubular member and configured so as to support a lamp shade. Finally, a lampshade is supported on the support member.

### BACKGROUND OF THE INVENTION

The present invention relates to lamps and lampshades, and more particularly to a lamp having a lampshade made of the shell of an egg and to the manner of their interassembly.

Lamps of various types are well known in the art and serve at least one of two purposes, namely lighting and aesthetic or decorative purposes. Numerous types of lamps are known which have a decorative aspect thereto, for example, crystal chandeliers, lava lights and table lamps of various styles. Table lamps in particular are also known to have many different types of lampshades which provide an attractive appearance to the lamp and also control light given off when the lamp is turned on.

### SUMMARY OF THE DISCLOSURE

It is an object of the present invention to provide a new, unique lamp which is aesthetically appealing and gives off a desirable lighting effect and appearance.

Pursuant to this object, and others which will become apparent hereafter, in one form thereof, the present invention comprises a lamp having a base, and a candle-like tubular member with a top and a bottom, the bottom being attached to the base. A light socket is arranged at the top of the tubular member. A lampshade support member is arranged at the top region of the tubular member and is configured to support a lampshade made of an egg shell, which is formed to enclose a light bulb. Finally, the lampshade is supported on the support member.

In another embodiment of the invention, the support member has a rim that defines an outer periphery and an inner periphery. A mesh extends from the inner periphery to form a center opening. The mesh is deformable and is attached to the tubular member by friction.

The rim and the mesh are made of a material which is heat resistant. Furthermore, the mesh is made of a material which can be deformed and maintains the deformed position. A suitable material for the rim and the mesh is metal, for example, stainless steel.

As noted, the lampshade may be an eggshell which has an opening at one end that fits over a light bulb mounted in the light socket. In still another embodiment of the invention, the edge of the hole is coated with silicone to strengthen the eggshell and prevent breakage.

Yet another embodiment of the invention provides a decorative rendition on the outer surface of the shell and/or designs cut through the shell to permit light to escape directly.

Other features and advantages of the present invention will become apparent from the following description of the invention which refers to the accompanying drawings.

### BRIEF DESCRIPTION OF THE DRAWINGS

FIG. 1 is a perspective view of a candelabra style lamp and lampshades pursuant to one form of the invention;

FIG. 2 is a perspective view showing the lampshade and the lampshade support;

FIG. 3 is a side view of the lampshade support;

FIG. 4 is a top view of the lampshade support;

FIG. 5 shows the lampshade and another embodiment of the lampshade holder.

### DETAILED DESCRIPTION OF THE INVENTION

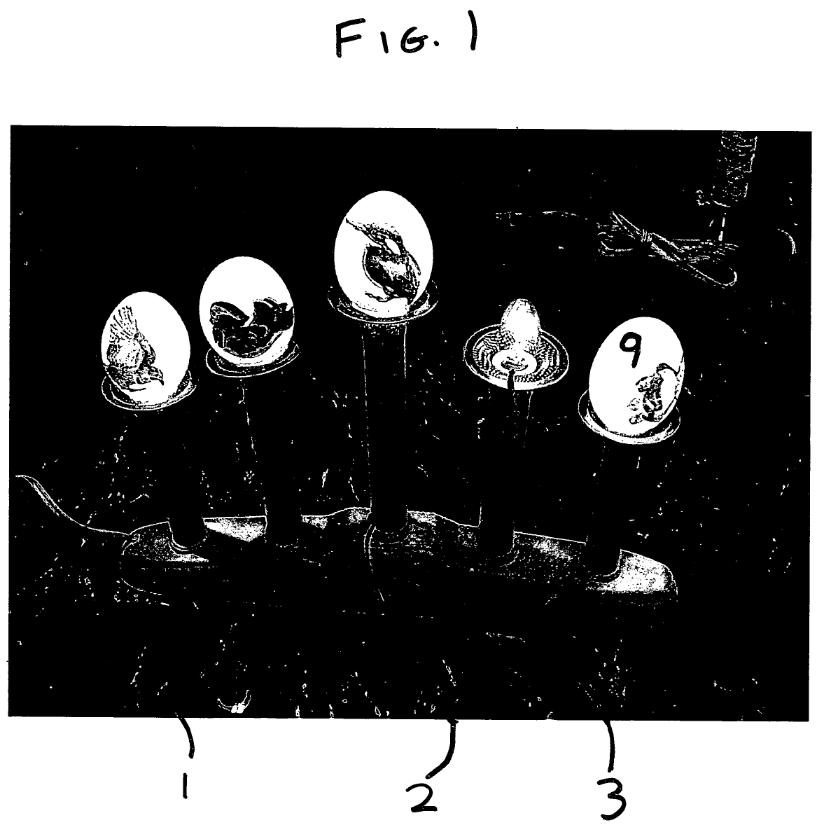

FIG. 1 shows a candelabra 1 constructed pursuant to one form of the present invention. The candelabra 1 can have any number of candle members 2 that are essentially hollow tubes, e.g., candelabra-sized plastic candle covers. The lower end of each tube 2 is mounted to a base 3 and an upper end of each tube has an electrical socket into which a lightbulb 4 can be screwed. A lampshade support member 5 is mounted to the tube 2 at or near the upper end thereof.

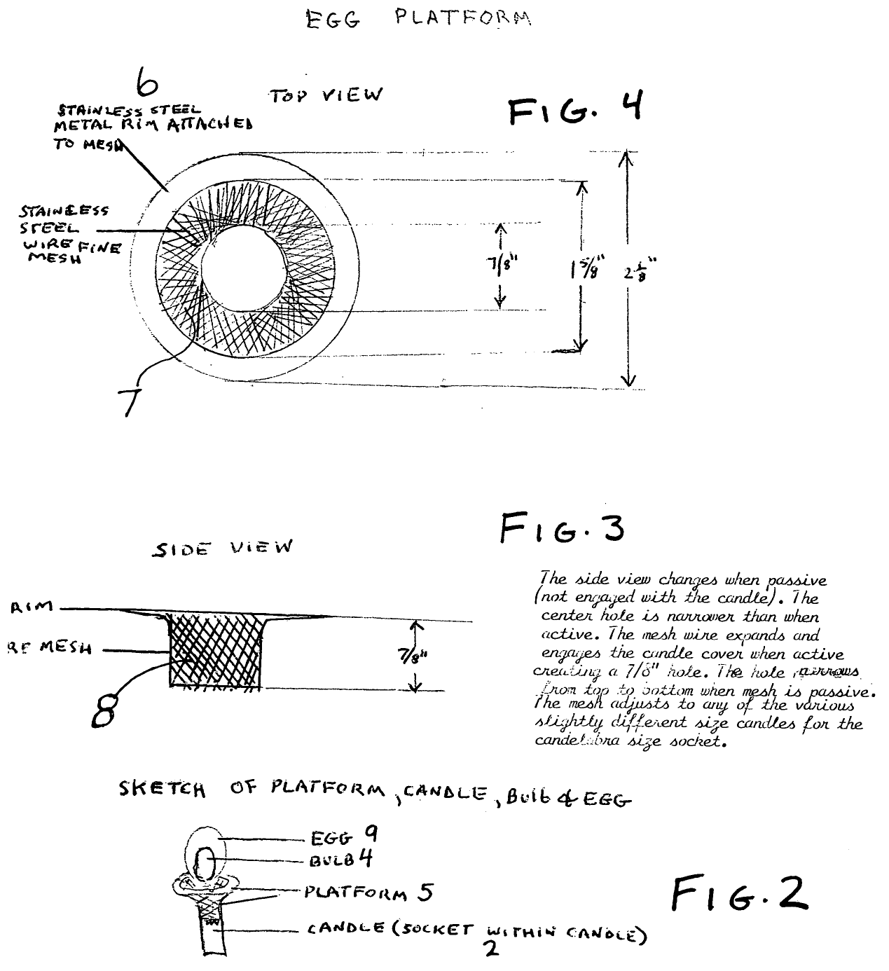

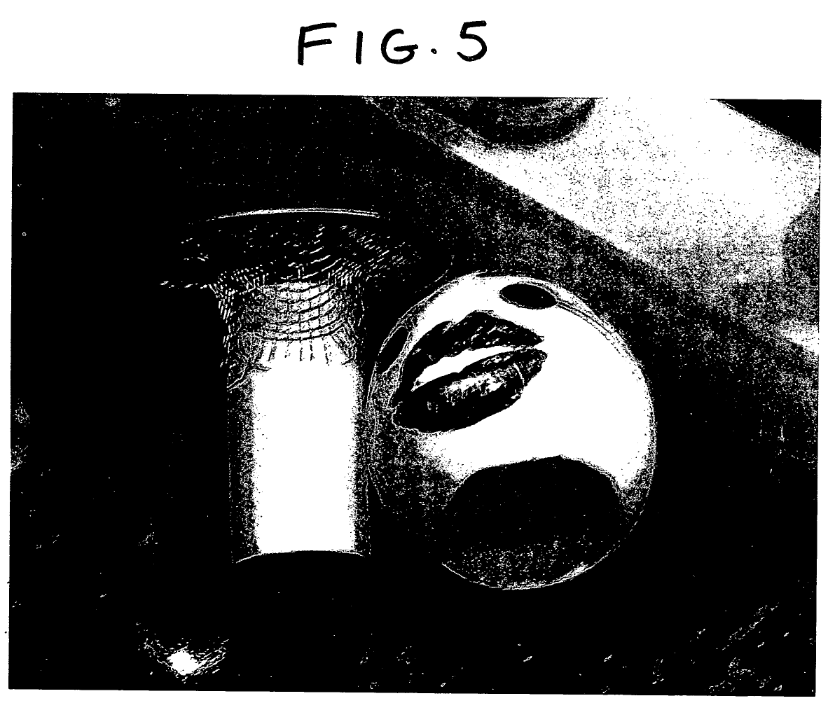

As can be seen in FIGS. 2-4, the support member 5 has a rim 6 made of a material that can withstand the heat generated by the bulb 4. In the present embodiment, the rim 6 is made of a metal such as stainless steel. A mesh, in this case, stainless steel wire, extends from the inner diameter of the rim 6 toward a central circumference substantially equal to the outer circumference of the tube 2. The mesh 7 has a longitudinally extending portion 8 that extends downwardly from the rim 6. This longitudinally extending portion 8 has a length sufficient to permit the support member 5 to be mounted on the tube 2 by conforming the mesh 7 to have a friction fit with the tube 2. The rim 6 of the support member 5 and a portion of the mesh 7 are substantially level with the upper end of the tube 2 in the embodiment shown in FIG. 1. However, the rim can also be above or below the upper end of the tube 2, depending upon the size of the shade employed.

The shade 9, seen in FIGS. 1, 2 and 5, is made of an eggshell. As more clearly seen in FIG. 5, the shade 9 has a hole 10 in the bottom of the shell which is of a size sufficient to pass over the bulb 4. The shell rests on the support member 5. As can be seen in FIGS. 1 and 5, the shade 9 can either be unadorned or have any one of a wide variety of designs or images thereon. The shade 9 provides a warm glow when the lightbulb 4 is illuminated.

Preferably, the hole 10 is at the large end of the eggshell. The hole is cut in the eggshell along an axis substantially coaxial with the longitudinal axis of the egg. The cut is made in the following manner. First, the center point of the egg on the large end is marked, for example, by a plus sign or an “X”. A first cut is made across one of the two lines forming the mark and a second cut is made at a right angle to the first cut. A rotary blade can be used to make these cuts and then additional cuts are made between the first two cuts so that the shell forms triangles which are broken off to create the opening 10. The ideal size of the hole is approximately 1 inch, but holes of larger or smaller size are possible depending upon the overall size of the egg and the bulb being used.

After the hole is cut, the contents of the egg are removed and the inside of the eggshell is washed out. After drying, any rough spots on the perimeter of the hole 10 are trimmed. The perimeter of the hole 10 is then provided with a non-flammable material which will give strength to the perimeter region. A suitable material is silicone, for example, 100 percent silicone architectural grade. At this point, if desired, a decoration is provided to the outer surface of the eggshell.

The bulb 4 is preferably a candelabra-based bulb of about 4 or 5 watts. A bulb of this wattage is suitable for safe use with a large chicken eggshell. If the eggshell is larger, for example, from a larger animal such as an ostrich, a correspondingly larger and more powerful bulb can be used, for example, 7 watts or larger.

The eggshell 9 can also be dyed or decorated by colors or with decorative, adherable decals Furthermore, the eggshell 9 can be cut with various patterns, similarly to a pumpkin, so that the light can pass directly through slots or cuts.

The decals may have their own adhesive by which to adhere to the eggshell and may have an outer protective transparent covering applied thereto.

FIG. 5 shows another embodiment of the invention in which the support member 5 is mounted on a sleeve 11. The sleeve is then slid over the bulb socket of a lamp.

The support member can also be used to support shades made of materials other than eggshells, so long as the shades are relatively light in weight so that the support member can support the weight of the shade.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. An lamp assembly, comprising:
a base;
a tubular member having a top and a bottom, the bottom being supported by the base;
a lampshade support member arranged at the top of the tubular member and configured so as to support a lampshade;
a lampshade supported on the support member; and
an electrical light arranged in the top of the tubular member.

2. The assembly as in claim 1, wherein the support member has a rim that defines an outer periphery and an inner periphery, and a mesh extending from the inner periphery to form a center opening, the mesh being deformable and resiliently attachable to the tubular member by friction.

3. The assembly as in claim 2, wherein the rim and the mesh are made of metal.

4. The assembly as in claim 3, wherein the metal is stainless steel.

5. The assembly as in claim 1, wherein the rim has a round periphery.

6. The assembly as in claim 1, wherein the lampshade is an eggshell.

7. The assembly as in claim 6, wherein the light comprises a light bulb mounted in a light socket, the eggshell having a hole to fit over the light bulb.

8. The assembly as in claim 7, wherein an edge of the hole is coated with silicone.

9. The assembly as in claim 6, wherein the eggshell is dyed.

10. The assembly as in claim 6, wherein the eggshell has a design cut through the shell.

11. The assembly as in claim 6, including a decorative pattern applied to an outer surface of the eggshell and illuminated by the light.

12. The assembly of claim 6, including a plurality of additional tubular members supported on the base, and a plurality of tubular members, electrical lights and eggshell lamp shades therefor.

13. A combination comprising:
a lamp shade holder that has a rim that defines an outer periphery and an inner periphery, and a mesh extending from the inner periphery to form a center opening, the mesh being deformable; and
a lamp shade that rests on the lamp shade holder.

14. The combination as in claim 13, wherein the lampshade is an eggshell having a hole in one end so as to fit over a light bulb.

15. The combination as in claim 14, wherein an edge of the hole is coated with silicone.

16. The combination as in claim 13, and further comprising a sleeve, the mesh being attached to the sleeve by friction.

17. The combination as in claim 13, wherein the rim and the mesh are made of metal.

18. A method for producing a lampshade made of an eggshell, comprising the steps of:
marking one end of an egg with at least first and second lines;
making a first cut across one of the lines;
making a second cut on another of the lines;
subsequently making additional cuts between the first two cuts so as to form triangles with the eggshell;
removing the triangles to form a opening;
emptying the contents of the egg;
washing an interior of the egg;
drying the eggshell;
trimming any rough spots on a perimeter of the opening; and
coating an edge of the opening with a non-flammable material that strengthens the edge.

19. A method according to claim 18, wherein the edge of the opening is coated with silicone.
